(19) United States
(12) Patent Application Publication
(10) Pub. No.: US 2015/0370155 A1
(43) Pub. Date: Dec. 24, 2015

(54) Projector Using Glass Phosphor As a Color Mixing Element

(71) Applicants: NATIONAL SUN YAT-SEN UNIVERSITY, Kaohsiung City (TW); TAIWAN COLOR OPTICS, INC., Taichung City (TW)

(72) Inventors: Wood-Hi CHENG, Kaohsiung City (TW); Yung-Peng Chang, Taichung City (TW); Chun-Chin Tsai, Kaohsiung City (TW); Ming-Chang Shih, Kaohsiung City (TW); Wen-How Lan, Kaohsiung City (TW); Yi-Chung Huang, Kaohsiung City (TW); Wei-Chih Cheng, Kaohsiung City (TW)

(21) Appl. No.: 14/311,940

(22) Filed: Jun. 23, 2014

(51) Int. Cl. G03B 21/20

(52) U.S. Cl. CPC G03B 21/204; G03B 21/2066

(57) ABSTRACT

A projector using glass phosphor as a color mixing element includes: a laser light source capable of producing light; an optical system, the color mixing member, a reflection element and an imaging system disposed on a light transmission path. The optical system includes a color wheel, the light will be converted into light beams of different colors when passing through the color wheel. The color mixing element is located between the laser light source and the optical system and made of glass phosphor, and a glass transition temperature of the glass phosphor being higher than 500° C. The imaging system serves to convert the light beams into an image. The use of the heat-resistant glass phosphor as the color mixing element enables the projector to have a wide color gamut and an adjustable color gamut.

### BACKGROUND OF THE INVENTION

1. Field of the Invention

The present invention relates to a projector, and more particularly to a projector using glass phosphor as a color mixing element.

2. Description of the Prior Art

Projector is widely used in various applications, such as conference room presentation, commercial projection screen or television, due to one of the characteristics of the projector is that it can produce a large size image.

The imaging principle of the projector is that a high brightness halogen bulb is used as a light source which is then divided into three primary colors by filter, color wheel or spectroscope and finally projected onto projection screen. Image is transmitted to the lens and then projected on the projection screen or wall through transmission or reflection of light beam. Projection screen generally includes DLP (digital light processing), 3 LCD (liquid crystal display) and LCoS (liquid crystal on Silicon) types in terms of imaging technology.

DLP technology, by relying on the eye's persistence of vision, projects an image of three primary colors at a very fast speed onto a projection screen, forming a full color image. The main components used in DLP are color wheel and DMD (digital micro-mirror device) chips. The color wheel divides the light source into red, green and blue colors or adds other colors, and these colors are sequentially projected on the DMD panel, then the images for these colors are reflected onto the lens by millions of micro-mirrors on the DMD chips, and finally forming image by projection.

However, the conventional projector uses a color wheel to divide a single color light source into light beams of different colors, without color mixing element, therefore, the color gamut is narrow.

The present invention has arisen to mitigate and/or obviate the afore-described disadvantages.

### SUMMARY OF THE INVENTION

The primary objective of the present invention is to provide a projector using glass phosphor as a color mixing element, which has a wide color gamut and an adjustable color gamut.

To achieve the above objective, a projector using glass phosphor as a color mixing element in accordance with the present invention comprises: a laser light source capable of producing light; an optical system, the color mixing member, a reflection element and an imaging system disposed on a light transmission path. The optical system includes a color wheel, the light will be converted into light beams of different colors when passing through the color wheel. The color mixing element is located between the laser light source and the optical system and made of glass phosphor, and a glass transition temperature of the glass phosphor being higher than 500° C.

The use of the heat-resistant glass phosphor as the color mixing element 21 enables the projector of the present invention to have a wide color gamut and an adjustable color gamut.

### BRIEF DESCRIPTION OF THE DRAWINGS

FIG. 1 is a flow chart of a projector using glass phosphor as a color mixing element in accordance with a preferred embodiment of the present invention; and

FIG. 2 is an exploded view of the projector using glass phosphor as a color mixing element in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

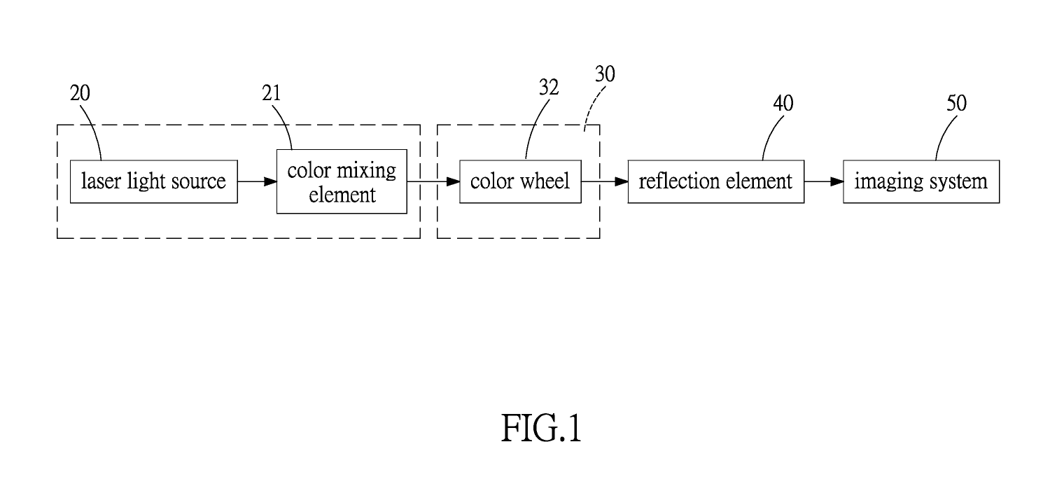

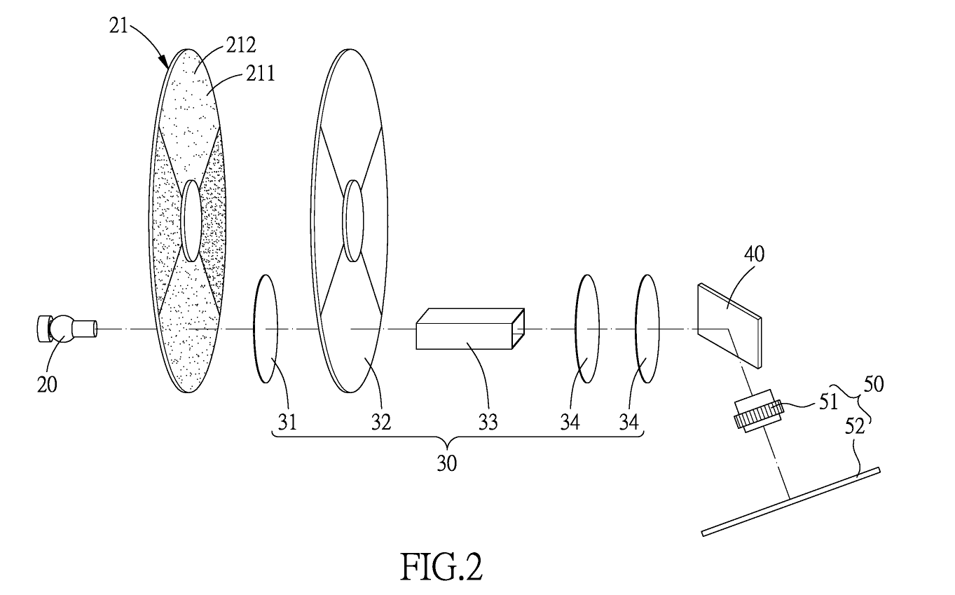

Referring to FIGS. 1 and 2, a projector using glass phosphor as a color mixing element in accordance with a preferred embodiment of the present invention comprises: a laser light source 20, an optical system 30, the color mixing element 21, a reflection element 40, and an imaging system 50.

The optical system 30 includes a condensing lens 31, a color wheel 32, an integrator rod 33 and at least one shaping lens 34. The light passes sequentially through the condensing lens 31, the color wheel 32 and the shaping lens 34. The light is condensed by the condensing lens 31 and then passes through the color wheel 32. When passing through different color gamuts of the color wheel 32, the light will be converted into light beams of different color. The integrator rod 33 serves to homogenize the light beams, and the shaping lens 34 adjusts and renders the light beams parallel.

The color mixing element 21 is disposed on the light transmission path and located between the laser light source 20 and the optical system 30. The color mixing element 21 is made of glass phosphor which is formed by glass 211 bonded or sintered with phosphor powder 212. The glass 211 can be sodium glass consisting of SiO₂, Al₂O₃ and NaO, or phosphate glass which consists of P₅O₂, SnO and BaO. The phosphor powder 212 is made of the phosphor material, including YAG (Yttrium aluminium garnet) or Nitride. The glass transition temperature of the glass phosphor is higher than 500° C. The color mixing element 21 can be added with different phosphor powders 212 to create a plurality of color gamuts.

The reflection element 40 is disposed on the light transmission path. In this embodiment, the reflection element 40 is a digital micro-mirror device.

The imaging system 50 is disposed on the light transmission path and includes an imaging lens 51 and an imaging screen 52. Light is converted by the imaging lens 51 of the imaging system 50 into an image, and then the image is projected on the imaging screen 52.

The use of the heat-resistant glass phosphor as the color mixing element 21 enables the projector of the present invention to have a wide color gamut and an adjustable color gamut. Furthermore, the color mixing element 21 of the present invention is completely free of adhesive, and is a glass phosphor formed by bonding or sintering of phosphor powder 212 and glass 211. Glass has better resistance to high temperature than high molecular adhesive, which permits the color mixing element 21 to maintain optical characteristic while being irradiated by high power laser source. Or the phosphor powder 212 can be mixed in different proportions with the color mixing element 21 to achieve the best light efficiency, which considerably improves illumination quality and color saturation.

While we have shown and described various embodiments in accordance with the present invention, it is clear to those skilled in the art that further embodiments may be made without departing from the scope of the present invention.

What is claimed is:

1. A projector using glass phosphor as a color mixing element comprising:
a laser light source capable of producing a light;
an optical system disposed on a light transmission path and including a color wheel, the light will be converted into light beams of different colors when passing through the color wheel;
the color mixing element disposed on the light transmission path and located between the laser light source and the optical system, the color mixing element being made of glass phosphor, and a glass transition temperature of the glass phosphor being higher than 500° C.;
a reflection element disposed on the light transmission path; and
an imaging system disposed on the light transmission path to convert the light beams into an image.

2. The projector using glass phosphor as the color mixing element as claimed in claim 1, wherein the optical system includes a condensing lens and a shaping lens, the light passes sequentially through the condensing lens, the color wheel and the shaping lens, the condensing lens condense or homogenize the light before the light passes through the color wheel, and the shaping lens renders the light beams parallel.

3. The projector using glass phosphor as the color mixing element as claimed in claim 1, wherein the imaging system includes an imaging lens and an imaging screen.

4. The projector using glass phosphor as the color mixing element as claimed in claim 1, wherein the color mixing element is made of glass phosphor which is formed by glass bonded or sintered with phosphor powder, the glass is sodium glass consisting of SiO₂, Al₂O₃ and NaO, or phosphate glass which consists of P₅O₂, SnO and BaO, or the phosphor powder is made of phosphor material, including Yttrium aluminium garnet or Nitride.

5. The projector using glass phosphor as the color mixing element as claimed in claim 1, wherein the reflection element is a digital micro-mirror device.
